(19) United States
(12) Patent Application Publication
(10) Pub. No.: US 2023/0152242 A1
(43) Pub. Date: May 18, 2023

(54) CONTINUOUS CASTING BILLET SURFACE DETECTION SYSTEM AND METHOD BASED ON TWO-DIMENSIONAL AND THREE-DIMENSIONAL COMBINED IMAGING

(71) Applicant: BAOSHAN IRON & STEEL CO., LTD., Shanghai (CN)

(72) Inventors: Tiegen PENG, Shanghai (CN); Wei YUAN, Shanghai (CN); Yonghui HE, Shanghai (CN); Yong ZHOU, Shanghai (CN); Dexiang ZONG, Shanghai (CN); Shuishan YANG, Shanghai (CN)

(73) Assignee: BAOSHAN IRON & STEEL CO., LTD., Shanghai (CN)

(21) Appl. No.: 17/919,591

(22) PCT Filed: Mar. 8, 2021
(86) PCT No.: PCT/CN2021/079486

§ 371 Date: Oct. 18, 2022

(30) Foreign Application Priority Data
Apr. 28, 2020 (CN) 202010348870.3

(51) Int. Cl. G01N 21/89; H04N 23/90

(52) U.S. Cl. CPC G01N 21/8914; H04N 23/90; G01N 2021/8918

(57) ABSTRACT

A surface detection system and method for continuous casting billet using two-dimensional and three-dimensional combined imaging. The detection system comprises an encoder (2), a position sensing mechanism, and a mounting rack (3), sequentially provided along a running direction of a continuous casting billet (1). The mounting rack (3) is provided with a three-dimensional imaging mechanism (4) and a two-dimensional imaging mechanism (5) sequentially along the running direction of the continuous casting billet (1). The position sensing mechanism starts the encoder (2), which records position information of the continuous casting billet (1). The mounting rack (3) is further provided with a lifting device (6). The three-dimensional imaging mechanism (4) moves up and down along the lifting device (6). The mounting rack (3) is further provided with an insulation plate (7). The two-dimensional imaging mechanism (5) is located above the insulation plate (7), and the continuous casting billet (1) is located below the insulation plate (7). Two-dimensional image data information and three-dimensional image data information are integrated to effectively detect real defects on the surface of the continuous casting billet (1) and filter pseudo defects.

### TECHNICAL FIELD

The present disclosure relates to machine vision-based detection technology for product surfaces, and specifically to a surface detection system and method for continuous casting billet using two-dimensional and three-dimensional combined imaging.

### BACKGROUND

In the field of online detection of the surface quality of continuous casting billets, two-dimensional imaging detection technology has been applied to the production site. For example, the patent “A method for online detection of cracks on continuous casting billet surfaces” (application No.: 200910092408.5) discloses a method that uses a green laser line light source as an illumination device, acquires images of the surface of high-temperature casting billets through a line scan CCD camera, and obtains grayscale images reflecting the surface condition of the high-temperature casting billets to realize the detection of defects on the surface of the continuous casting billet. It is difficult to effectively identify real defects in two-dimensional images due to the interference of scales and water marks on the surface of high-temperature casting billets.

In the three-dimensional imaging detection, for example, the patent “Laser scanning imaging nondestructive detection method for surface defects of continuous casting hot billet” (application No.: 201010167889.4) discloses a method using area scan CCD scanning laser beams to obtain the depth information of defects on the surface of the continuous casting billet. However, in the application of three-dimensional imaging detection, the crack-type defects are difficult to be effectively detected by three-dimensional imaging due to the small opening of cracks.

### SUMMARY

In view of the above defects in the prior art, the objective of the present disclosure is to provide surface detection system and method for continuous casting billet using two-dimensional and three-dimensional combined imaging. By integrating two-dimensional and three-dimensional image data information, the real defects on the surfaces of the continuous casting billet are effectively detected, and the pseudo defects are filtered.

To achieve the above objective, the following technical solutions are used in the present disclosure.

On one aspect, a surface detection system for continuous casting billet using two-dimensional and three-dimensional combined imaging, comprising:

an encoder, a position sensing mechanism, and a mounting rack, sequentially provided along a running direction of a continuous casting billet; wherein the mounting rack is sequentially provided with a three-dimensional imaging mechanism and a two-dimensional imaging mechanism along the running direction of the continuous casting billet;

the position sensing mechanism is used for activating the encoder, and the encoder is used for recording position information of the continuous casting billet;

the mounting rack is further provided with a lifting device, and the three-dimensional imaging mechanism moves up and down along the lifting device; and

the mounting rack is further provided with an insulation plate, the two-dimensional imaging mechanism is located above the insulation plate, the three-dimensional imaging mechanism can be moved to a detection position under the insulation plate during detection, and can be lifted to a top of the insulation plate after the detection is completed, and wherein the continuous casting billet is located below the insulation plate.

Preferably, the three-dimensional imaging mechanism and the two-dimensional imaging mechanism each comprises a camera and a light source.

Preferably, the camera of the three-dimensional imaging mechanism is an area scan camera and the light source of the three-dimensional imaging mechanism is a line structured laser source.

Preferably, the camera of the two-dimensional imaging mechanism is a line scan camera.

Preferably, the insulation plate is provided with a two-dimensional imaging channel corresponding to the two-dimensional imaging mechanism and with a three-dimensional imaging channel corresponding to the three-dimensional imaging mechanism, and a push-pull insulation device is arranged between the three-dimensional imaging channel and the three-dimensional imaging mechanism.

Preferably, the push-pull insulation device is driven by a cylinder to move above the three-dimensional imaging channel, so as to block or expose the three-dimensional imaging channel.

Preferably, the three-dimensional imaging mechanism is provided with an insulation protection device.

Preferably, the insulation protection device rotates around an imaging window of the three-dimensional imaging mechanism via a rotating shaft.

Preferably, the position sensing mechanism is a photoelectric sensor, which comprises a transmitting end and a receiving end.

On another aspect, the present disclosure provides a surface detection method for continuous casting billet using two-dimensional and three-dimensional combined imaging, wherein the surface detection system for continuous casting billet using two-dimensional and three-dimensional combined imaging integrates the data information collected by the three-dimensional imaging mechanism and the two-dimensional imaging mechanism based on a relative position relationship between the three-dimensional imaging mechanism and the two-dimensional imaging mechanism to achieve detection and identification of defects on a surface of the continuous casting billet.

The detection method comprises:

setting the horizontal distance between a center point of the two-dimensional imaging mechanism and a transmitting end of the photoelectric sensor as D, and setting the horizontal distance of the center point of the two-dimensional imaging mechanism and the center point of the three-dimensional imaging mechanism as L; wherein

as the continuous casting billet passes the photoelectric sensor, a photoelectric signal between the transmitting end and the receiving end of the photoelectric sensor is blocked, and the system acquires a signal from the encoder and starts recording position information of the continuous casting billet along its running direction;

when the head of the continuous casting billet passes the photoelectric sensor and an accumulated running distance reaches D-L, the three-dimensional imaging mechanism starts working; when an accumulated distance reaches D, the two-dimensional imaging mechanism starts working; and when the tail of the continuous casting billet passes the photoelectric sensor, the three-dimensional imaging mechanism continues to detect the continuous casting billet surface having a distance D-L from the tail end of the continuous casting billet, and the two-dimensional imaging mechanism continues to detect the continuous casting billet surface having a distance D from the tail end of the continuous casting billet; and

when assessing image data acquired by the two-dimensional imaging mechanism at a certain position, referring to three-dimensional depth information acquired by the three-dimensional imaging mechanism corresponding to the position; if the three-dimensional depth information is less than a set threshold, it is determined that the continuous casting billet has no defect on its surface; and if the three-dimensional depth information is greater than the set threshold, it is determined that the continuous casting billet has defects on its surface.

In the above technical solutions, the surface detection system and method for continuous casting billet using two-dimensional and three-dimensional combined imaging provided by the present disclosure is for online detection of the surface quality of the continuous casting billet. The surface detection system and method use two-dimensional combined imaging to integrate image information, remove pseudo defects without depth information such as scales and water marks, and retain the crack-type defects having small depths, so as to achieve the effective detection of defects on the surface of continuous casting billets.

### BRIEF DESCRIPTION OF THE DRAWINGS

FIG. 1 is a schematic diagram of the framework in an embodiment of a detection system in the present disclosure; and

FIG. 2 is a schematic diagram of the structure in an embodiment of a detection system in the present disclosure; and

FIG. 3 is a schematic diagram of an insulation plate in an embodiment of a detection system in the present disclosure;

FIG. 4 is a schematic diagram of a push-pull insulation device in an embodiment of a detection system in the present disclosure;

FIG. 5 is a schematic diagram of an insulation protection device in an embodiment of a detection system in the present disclosure;

FIG. 6 is a schematic flowchart in an embodiment of a detection method in the present disclosure;

FIG. 7 is a schematic diagram of imaging in an embodiment of a detection method in the present disclosure; and

FIG. 8 is a schematic diagram of detection for a surface of a continuous casting billet in an embodiment of a detection method in the present disclosure.

### DETAILED DESCRIPTION OF THE EMBODIMENTS

The technical solutions of the present disclosure are further described below combined with the accompanying drawings and embodiments.

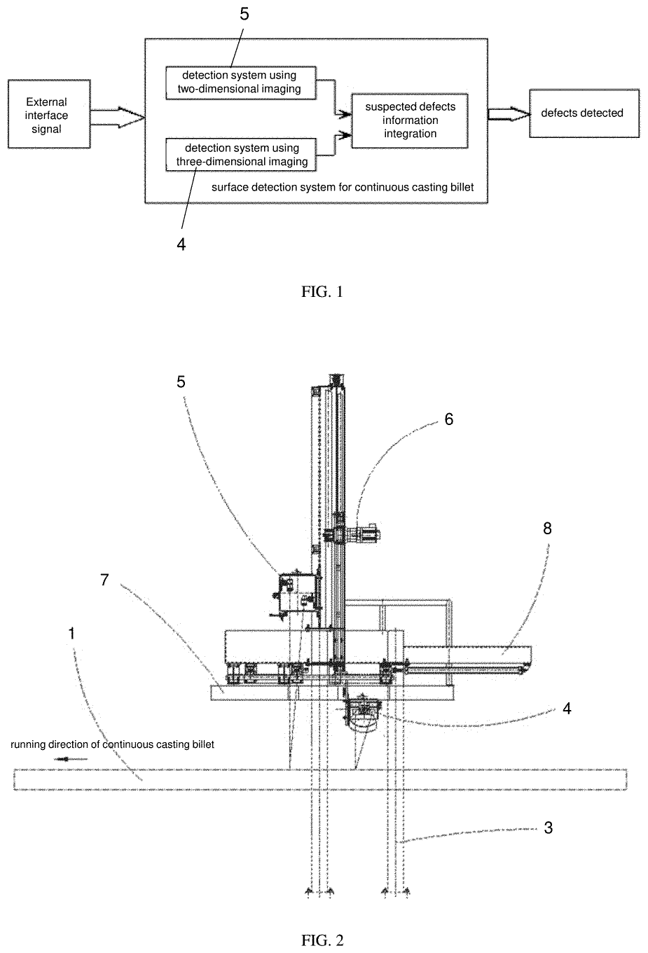

As shown in FIGS. 1-2, the surface detection system for continuous casting billet using two-dimensional and three-dimensional combined imaging provided in the present disclosure comprises an encoder 2, a position sensing mechanism, and a mounting rack 3, sequentially provided along a running direction (the direction indicated by the arrow in FIG. 1) of a continuous casting billet 1.

A three-dimensional imaging mechanism 4 and a two-dimensional imaging mechanism 5 are sequentially fixed and installed on the mounting rack 3 along the running direction of the continuous casting billet 1.

The position sensing mechanism senses the passage of the continuous casting billet 1 and simultaneously activates the encoder 2, which records the position information of the continuous casting billet 1.

The mounting rack 3 is further provided with a lifting device 6, and the three-dimensional imaging mechanism 4 moves up and down by the lifting device 6.

The mounting rack 3 is further provided with an insulation plate 7, the two-dimensional imaging mechanism 5 is located above the insulation plate 7, the three-dimensional imaging mechanism 4 can move up and down, and the continuous casting billet 1 is located below the insulation plate 7.

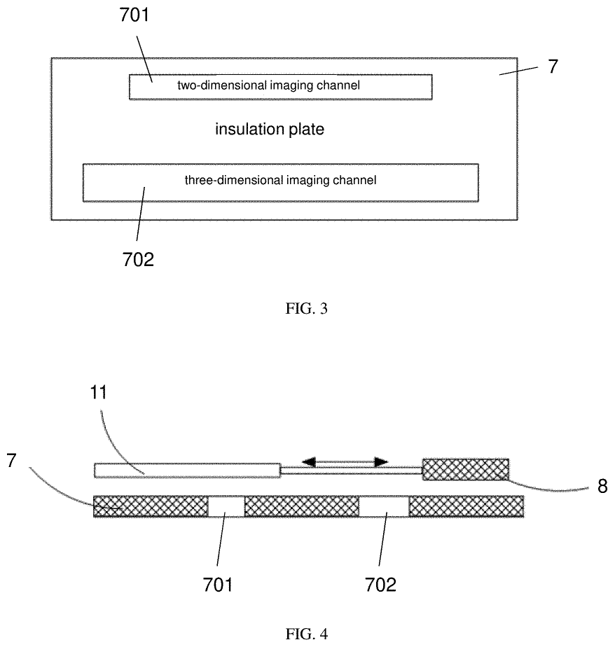

As shown in FIG. 3, the insulation plate 7 is provided with a two-dimensional imaging channel 701 corresponding to the two-dimensional imaging mechanism 5 and with a three-dimensional imaging channel 702 corresponding to the three-dimensional imaging mechanism 4, and a push-pull insulation device 8 is arranged between the three-dimensional imaging channel 702 and the three-dimensional imaging mechanism 4.

As shown in FIG. 4, the push-pull insulation device 8 is driven by a cylinder 11 to move above the three-dimensional imaging channel 702 so as to open and/or close the three-dimensional imaging channel 702.

The push-pull insulation device 8 is provided in front of the imaging window of the three-dimensional imaging mechanism 4, which can be lifted by lifting device 6.

Since the two-dimensional imaging mechanism 5 is far away from the continuous casting billet 1 and is not adjusted up and down, the two-dimensional imaging channel 701 does not close without the continuous casting billet 1 passing through. The three-dimensional imaging mechanism 4 is lifted above the push-pull insulation device 8 after the detection is complete. The push-pull insulation device 8 is driven by the cylinder 11 to move over the three-dimensional imaging channel 702 on the insulation plate 7, closing the three-dimensional imaging channel 702 and stopping the thermal radiation generated by the continuous casting billet 1 from affecting the three-dimensional imaging mechanism 4 when the three-dimensional detection system is not working.

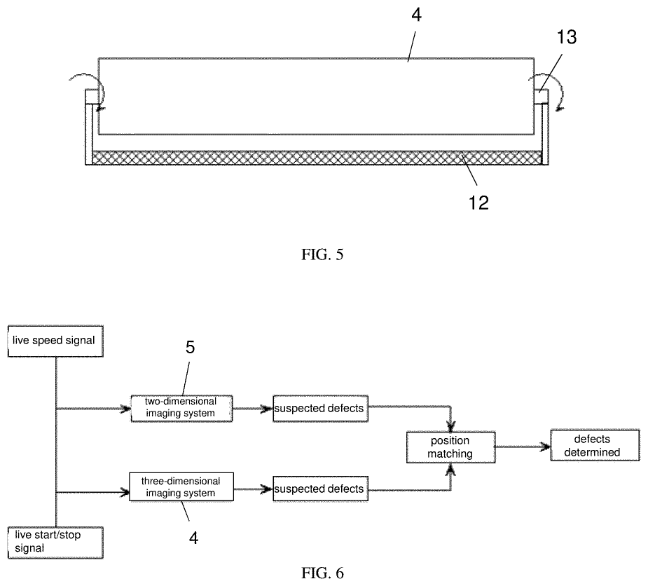

As shown in FIG. 5, the three-dimensional imaging mechanism 4 is further provided with an insulation protection device 12.

The insulation protection device 12 rotates around an imaging window of the three-dimensional imaging mechanism 4 via a rotating shaft 13.

When the detection system of the present disclosure detects that the head of the continuous casting billet 1 passes through the position sensing mechanism, prior to passing under the imaging mechanism, the push-pull insulation device 8 is removed to expose the three-dimensional imaging channel 702, the three-dimensional imaging mechanism 4 is lowered to a suitable position above the continuous casting billet 1 by the lifting device 6, and the insulation protection device 12 of the three-dimensional imaging mechanism 4 is removed to start the detection. When the tail of the continuous casting billet 1 has completely passed the detection position of the three-dimensional imaging mechanism, the three-dimensional imaging mechanism 4 is raised above the push-pull insulation device 8 by the lifting device 6, and the push-pull insulation device 8 is moved to close the three-dimensional imaging channel 702. The two-dimensional imaging mechanism 5 performs imaging through the two-dimensional imaging channel 701 on the insulation plate 7. Since the two-dimensional imaging mechanism 5 is far away from the continuous casting billet 1 and the through hole on the insulation plate 7 is narrow, the thermal radiation has little influence on the two-dimensional imaging mechanism 5. Therefore, the two-dimensional imaging channel 701 is not closed after the detection is completed.

As shown in FIG. 6, the present disclosure further provides a surface detection method for continuous casting billet using two-dimensional and three-dimensional combined imaging, which uses a relative position relationship between the three-dimensional imaging mechanism 4 and the two-dimensional imaging mechanism 5, and integrates the data information collected by the three-dimensional imaging mechanism 4 and the two-dimensional imaging mechanism 5 to achieve detection and identification of defects on a surface of the continuous casting billet 1. The integration process of image information refers to a process in which the two-dimensional imaging mechanism 5 and three-dimensional imaging mechanism 4 receive the speed signal from the encoder 2 and the start/stop signal from the position sensing mechanism, and then information about the actual position of these images on the surface of the continuous casting billet can be obtained simultaneously when acquiring two-dimensional and three-dimensional image data. When the two-dimensional imaging mechanism 5 is operated by detection algorithms (such as filtering, gradient operations, etc.) to obtain the area where the suspected defects such as objects are located in the image area, the three-dimensional imaging mechanism 4 obtains information of the depth change of the surface of the continuous casting billet 1 through the three-dimensional image and determines the area beyond the set threshold. If the suspected defect area detected by the two-dimensional imaging mechanism 5 and the suspected area obtained by the three-dimensional imaging mechanism 4 is basically the same, it can be determined that the area is where the defects are located. For scales, water marks and other pseudo-defects without depth change, the area where these defects are located cannot be obtained by the three-dimensional imaging mechanism 4, but the area where the crack-type defects having with a certain depth are located will be detected by the two-dimensional imaging mechanism 5 and three-dimensional imaging mechanism 4 at the same time. In this way, the two-dimensional imaging mechanism 5 and three-dimensional imaging mechanism 4 achieve the purpose of removing pseudo-defects through the integration of position information.

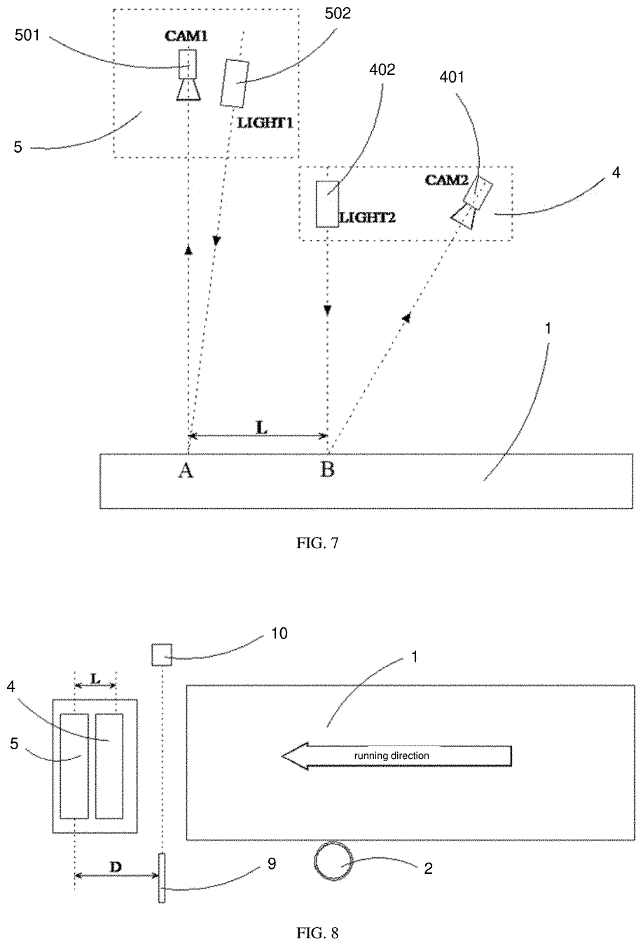

As shown in FIG. 7, both the three-dimensional imaging mechanism 4 and the two-dimensional imaging mechanism 5 are arranged above the continuous casting billet 1. The two-dimensional imaging mechanism 5 comprises a set of line scan camera 501 and a matching light source 502, and the three-dimensional imaging mechanism 4 comprises a set of line structured laser source 401 and an area scan camera 402.

The corresponding imaging position of the two-dimensional imaging mechanism 5 is A, the corresponding imaging position of the three-dimensional imaging mechanism 4 is B, and the center imaging points of A and B are at a distance of L. When the continuous casting billet 1 passes under the detection system of the present disclosure, the three-dimensional imaging mechanism 4 and the two-dimensional imaging mechanism 5 image the surface of the continuous casting billet 1 and obtain the image data information of the surface of the continuous casting billet 1. The two-dimensional image data of a certain location is marked as IMG1 and the corresponding three-dimensional image data is marked as IMG2. In this embodiment, IMG1 is a grayscale image obtained by imaging with an industrial line scan CCD camera, and IMG2 is an image having three-dimensional depth information obtained using a scheme of structured light imaging. If the change of the three-dimensional depth information in IMG2 is less than a set threshold, it can be considered that there is no defect. In the surface detection for continuous casting billet, for instance, the threshold is set to be 0.1 mm That is, if the depth of the defect is less than 0.1 mm, then it can be considered that there is no defect. The interference of scales and water marks can be filtered out quickly. Since most of the crack-type defects are located at the edges and ends, two-dimensional image data can be used as the main part and three-dimensional image data as the supplement when assessing defects. For defects located in the middle of the continuous casting billet, three-dimensional image data is used as the main part and two-dimensional image data is used as the supplement when assessing defects.

As shown in FIG. 8, when the continuous casting billet 1 passes the photoelectric sensor, the photoelectric signal between the transmitting end 9 and the receiving end 10 of the photoelectric sensor is blocked, and the detection system of the present disclosure detects the arrival of the head of the continuous casting billet 1. The detection system of the present disclosure acquires signals from the encoder 2 connected to the motion drive of the continuous casting billet 1 and starts recording the position information in the running direction of the continuous casting billet 1. When the head of the continuous casting billet passes the detection position of the photoelectric sensor and the accumulated running distance reaches D-L, the three-dimensional imaging mechanism 4 starts working. When the accumulated distance reaches D, the two-dimensional imaging mechanism 5 starts working. When the tail of the continuous casting billet 1 passes the photoelectric sensor, the three-dimensional imaging mechanism 4 continues to detect the continuous casting billet surface having a distance D-L from the tail end of the continuous casting billet 1, and the two-dimensional imaging mechanism 5 continues to detect the continuous casting billet 1 surface having a distance D from the tail end of the continuous casting billet.

It should be recognized by those of ordinary skill in the art that the above embodiments are used only to illustrate the disclosure and are not intended to be used as a limitation of the disclosure. Any variations and modifications of the above described embodiments will fall within the scope of the claims of the disclosure as long as they are within the substantial spirit of the present disclosure.

1. A surface detection system for continuous casting billet using two-dimensional and three-dimensional combined imaging, comprising:
an encoder, a position sensing mechanism, and a mounting rack, sequentially provided along a running direction of a continuous casting billet; wherein
the mounting rack is provided with a three-dimensional imaging mechanism and a two-dimensional imaging mechanism along sequentially the running direction of the continuous casting billet;
the position sensing mechanism is used for activating the encoder, and the encoder is used for recording position information of the continuous casting billet;
the mounting rack is further provided with a lifting device, and the three-dimensional imaging mechanism moves up and down along the lifting device; and
the mounting rack is further provided with an insulation plate, the two-dimensional imaging mechanism is located above the insulation plate, the three-dimensional imaging mechanism can move up and down, and the continuous casting billet is located below the insulation plate.

2. The surface detection system of claim 1, wherein the three-dimensional imaging mechanism and the two-dimensional imaging mechanism each comprises a camera and a light source.

3. The surface detection system of claim 2, wherein the camera of the three-dimensional imaging mechanism is an area scan camera and the light source of the three-dimensional imaging mechanism is a line structured laser source.

4. The surface detection system of claim 2, wherein the camera of the two-dimensional imaging mechanism is a line scan camera.

5. The surface detection system of claim 1, wherein the insulation plate is provided with a two-dimensional imaging channel corresponding to the two-dimensional imaging mechanism and with a three-dimensional imaging channel corresponding to the three-dimensional imaging mechanism, and a push-pull insulation device is arranged between the three-dimensional imaging channel and the three-dimensional imaging mechanism.

6. The surface detection system of claim 5, wherein the push-pull insulation device is driven by a cylinder and moves above the three-dimensional imaging channel, so as to block or expose the three-dimensional imaging channel.

7. The surface detection system of claim 5, wherein the three-dimensional imaging mechanism is provided with an insulation protection device.

8. The surface detection system of claim 7, wherein the insulation protection device rotates around an imaging window of the three-dimensional imaging mechanism via a rotating shaft.

9. The surface detection system of claim 1, wherein the position sensing mechanism is a photoelectric sensor, which comprises a transmitting end and a receiving end.

10. A surface detection method for continuous casting billet using two-dimensional and three-dimensional combined imaging, comprises: using the surface detection system of claim 1, and based on relative position relationship between the three-dimensional imaging mechanism and the two-dimensional imaging mechanism, integrating data and information collected by the three-dimensional imaging mechanism and the two-dimensional imaging mechanism to achieve detection and identification of defects on the surface of the continuous casting billet.

11. The surface detection method of claim 10, wherein the detection method comprises:
setting the horizontal distance between a center point of the two-dimensional imaging mechanism and a transmitting end of the photoelectric sensor as D, setting horizontal distance between the center point of the two-dimensional imaging mechanism and a center point of the three-dimensional imaging mechanism as L, wherein
as the continuous casting billet passes the photoelectric sensor, a photoelectric signal between the transmitting end and a receiving end of the photoelectric sensor is blocked, and the system acquires a signal from the encoder and starts recording position information of the continuous casting billet along its running direction;
when the head of the continuous casting billet passes the photoelectric sensor and an accumulated running distance reaches D-L, the three-dimensional imaging mechanism starts working; when the distance accumulates to D, the two-dimensional imaging mechanism starts working; and when the tail of the continuous casting billet passes the photoelectric sensor, the three-dimensional imaging mechanism continues to detect the continuous casting billet surface having a distance D-L from the tail end of the continuous casting billet, and the two-dimensional imaging mechanism continues to detect the continuous casting billet surface having a distance D from the tail end of the continuous casting billet; and
when assessing image data acquired by the two-dimensional imaging mechanism at a certain position, referring to three-dimensional depth information acquired by the three-dimensional imaging mechanism corresponding to the position; if the three-dimensional depth information is less than a set threshold, it is determined that the continuous casting billet has no defect on its surface; and if the three-dimensional depth information is greater than the set threshold, it is determined that the continuous casting billet has defects on its surface.
